(19) United States
(12) Patent Application Publication
(10) Pub. No.: US 2026/0042298 A1
(43) Pub. Date: Feb. 12, 2026

(54) THERMAL HEAD AND THERMAL PRINTER

(71) Applicant: KYOCERA Corporation, Kyoto (JP)

(72) Inventors: Kenichi KATO, Kirishima-shi, Kagoshima (JP); Makoto MIYAMOTO, Kirishima-shi, Kagoshima (JP)

(21) Appl. No.: 19/100,937

(22) PCT Filed: Aug. 1, 2023
(86) PCT No.: PCT/JP2023/028057

§ 371 Date: Feb. 4, 2025

(30) Foreign Application Priority Data
Aug. 5, 2022 (JP) 2022-125800

(51) Int. Cl. B41J 2/335; B41J 11/04

(52) U.S. Cl. CPC B41J 2/3351; B41J 2/33525; B41J 2/3353; B41J 2/3354; B41J 2/3355; B41J 11/04; B41J 2/3352

(57) ABSTRACT

A thermal head includes a substrate, a bonding material, an electrically conductive member, and an aluminum electrode. The bonding material is positioned on the substrate and contains gold and tin. The electrically conductive member is positioned on the bonding material. The aluminum electrode is positioned on the substrate and electrically connected to the electrically conductive member via the bonding material.

### CROSS-REFERENCE TO RELATED APPLICATIONS

This application is national stage application of International Application No. PCT/JP2023/028057, filed on Aug. 1, 2023, which designates the United States, and which claims the benefit of priority from Japanese Patent Application No. 2022-125800, filed on Aug. 5, 2022.

### TECHNICAL FIELD

Embodiments of this disclosure relate to a thermal head and a thermal printer.

### BACKGROUND OF INVENTION

Various kinds of thermal heads for printing devices such as facsimile machines and video printers have been proposed in the related art. For example, there is known a connection structure of an electronic component in which an aluminum wiring positioned on a substrate is plated and bonded using a bonding material.

### CITATION LIST

### Patent Literature

Patent Document 1: JP 61-244567 A

### SUMMARY

A thermal head according to an aspect of an embodiment includes a substrate, a bonding material, an electrically conductive member, and an aluminum electrode. The bonding material is positioned on the substrate and contains gold and tin. The electrically conductive member is positioned on the bonding material. The aluminum electrode is positioned on the substrate and is electrically connected to the electrically conductive member via the bonding material.

In addition, a thermal printer according to an aspect of the present disclosure includes the thermal head described above, a transport mechanism, and a platen roller. The transport mechanism transports a recording medium onto a heat generating part positioned on the substrate. The platen roller presses the recording medium.

### BRIEF DESCRIPTION OF THE DRAWINGS

FIG. 1 is an exploded perspective view schematically illustrating a thermal head according to an embodiment.

FIG. 2 is a plan view illustrating a schematic configuration of the thermal head illustrated in FIG. 1.

FIG. 3 is a cross-sectional view taken along line III-III of FIG. 2.

FIG. 4 is an enlarged cross-sectional view of a region A illustrated in FIG. 3.

FIG. 5 is an enlarged cross-sectional view of a region B illustrated in FIG. 4.

FIG. 6 is a schematic view of a thermal printer according to an embodiment.

### DESCRIPTION OF EMBODIMENTS

In a connection structure of the related art, there is room for improvement in durability.

Therefore, provision of a thermal head and a thermal printer with enhanced durability is expected.

Embodiments of a thermal head and a thermal printer disclosed in the present application will be described below with reference to the accompanying drawings. Note that this invention is not limited to the embodiments that will be described below.

### Embodiments

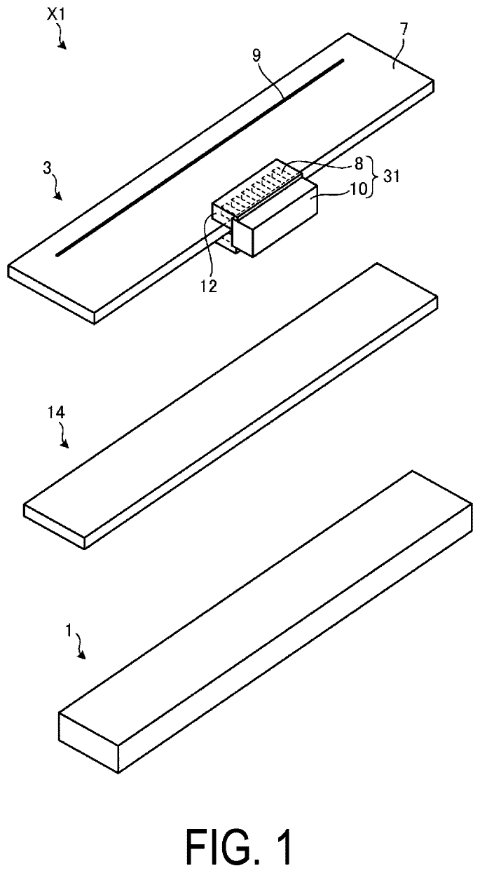

FIG. 1 is an exploded perspective view schematically illustrating a thermal head according to an embodiment. As illustrated in FIG. 1, a thermal head X1 according to the embodiment includes a head base 3, a connector 31, a sealing member 12, a heat dissipation body 1, and a bonding member 14. Note that the configuration of the thermal head X1 illustrated in FIG. 1 is merely an example, and for example, one or more members of the connector 31, the sealing member 12, the heat dissipation body 1, and the bonding member 14 need not necessarily be provided.

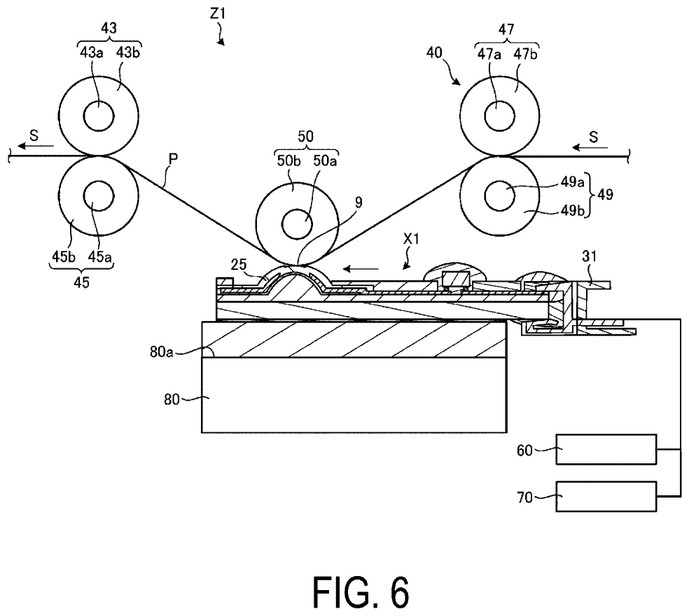

The heat dissipation body 1 dissipates surplus heat of the head base 3. The head base 3 is placed on the heat dissipation body 1 via the bonding member 14. The head base 3 performs printing on a recording medium P (see FIG. 6) by a voltage being applied from the outside. The bonding member 14 bonds the head base 3 and the heat dissipation body 1. The connector 31 electrically connects the head base 3 to the outside. The connector 31 includes a connector pin 8 and a housing 10. The sealing member 12 bonds the connector 31 and the head base 3.

The heat dissipation body 1 has a rectangular parallelepiped shape. The heat dissipation body 1 is made of, for example, a metal material such as copper, iron, or aluminum, and dissipates heat generated by heat generating parts 9 of the head base 3, especially heat not contributing to printing.

The head base 3 has a rectangular shape in plan view, and each member constituting the thermal head X1 is disposed on a substrate 7. The head base 3 performs printing on a recording medium P (see FIG. 6) in accordance with an electrical signal provided from the outside.

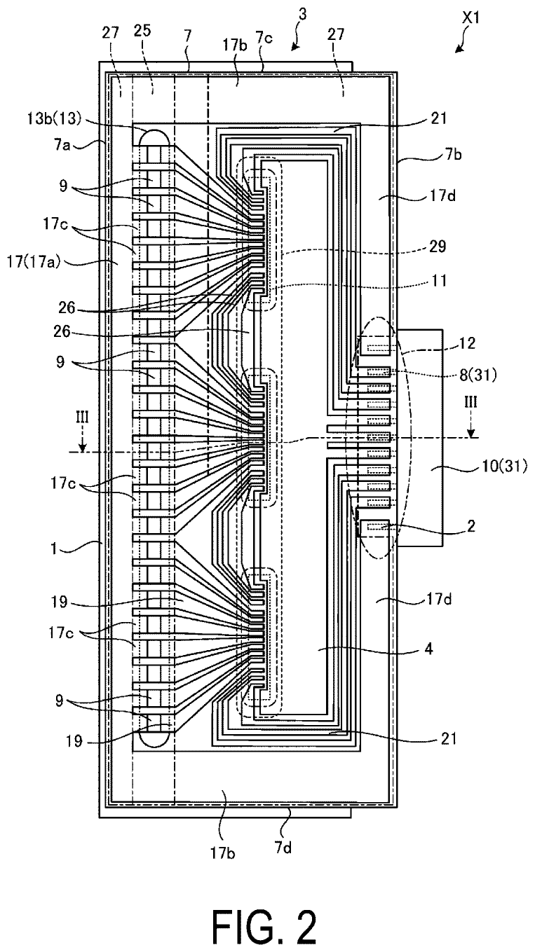

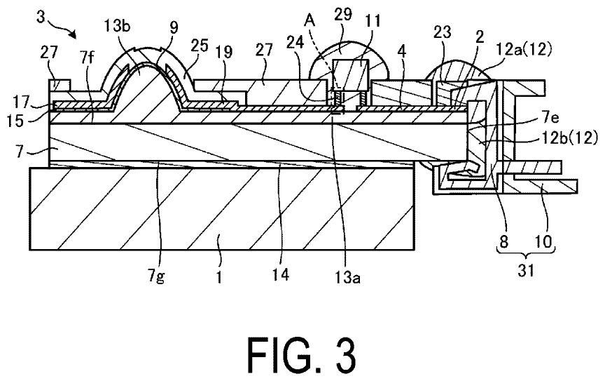

Next, the members constituting the thermal head X1 will be further described with reference to FIGS. 2 and 3. FIG. 2 is a plan view illustrating a schematic configuration of the thermal head illustrated in FIG. 1. FIG. 3 is a cross-sectional view taken along line III-III of FIG. 2. Note that in FIG. 2, a protective layer 25, a covering layer 27, and the sealing member 12 are indicated by dot-dash lines, and a covering member 29 is indicated by a broken line.

The head base 3 includes a substrate 7, heat generating resistors 15, a common electrode 17, individual electrodes 19, first connection electrodes 21, second connection electrodes 26, a ground electrode 4, connection terminals 2, an electrically conductive member 23, drive ICs 11, a bonding material 24, a covering member 29, a protective layer 25, and a covering layer 27. Note that the head base 3 need not necessarily include all of these members. In addition, the head base 3 may include a member other than these members.

The substrate 7 is disposed on the heat dissipation body 1 and has a rectangular shape in plan view. The substrate 7 has a first surface 7f, a second surface 7g, and a side surface 7e. The first surface 7f has a first long side 7a, a second long side 7b, a first short side 7c, and a second short side 7d. Members constituting the head base 3 are disposed on the first surface 7f. The second surface 7g is positioned on an opposite side to the first surface 7f. The second surface 7g is positioned on the heat dissipation body 1 side and is bonded to the heat dissipation body 1 via the bonding member 14. The side surface 7e connects the first surface 7f and the second surface 7g and is positioned on the second long side 7b side.

The substrate 7 is made of an electrically insulating material such as alumina ceramic or a semiconductor material such as single crystal silicon. Hereinafter, for convenience of description, the first surface 7f may be referred to as an “upper surface”, and the second surface 7g may be referred to as a “lower surface”. Similarly, with reference to the side surface 7e, the first surface 7f side may be referred to as “upper” or “above”, and the second surface 7g side may be referred to as “lower” or “below”.

The substrate 7 may include a heat storage layer 13 positioned on the first surface 7f. The heat storage layer 13 may include an underlying portion 13a and a raised portion 13b. The underlying portion 13a is positioned over the entire first surface 7f. The raised portion 13b rises in a thickness direction of the substrate 7 from the underlying portion 13a. In other words, the raised portion 13b protrudes in a direction away from the first surface 7f.

The raised portion 13b is positioned adjacent to the first long side 7a of the substrate 7 and extends in a main scanning direction. The raised portion 13b may have a substantially semi-elliptical cross section. Thereby, the protective layer 25 positioned on the heat generating part 9 favorably comes into contact with the recording medium P to be printed (see FIG. 6). A height of the heat storage layer 13 including the underlying portion 13a and the raised portion 13b from the first surface 7f of the substrate 7 may be set to 30 μm to 60 μm. The raised portion 13b is an example of a glaze.

The heat storage layer 13 is made of, for example, glass having low thermal conductivity and temporarily stores part of heat generated by the heat generating part 9. Thus, the time required to raise the temperature of the heat generating part 9 can be shortened, thereby enhancing the thermal response characteristics of the thermal head X1.

The heat storage layer 13 is formed by, for example, applying a predetermined glass paste, which is prepared by mixing a glass powder with an appropriate organic solvent, onto the first surface 7f by screen printing or the like, performing etching as necessary, and firing the glass paste.

The heat generating resistor 15 is positioned on an upper surface of the heat storage layer 13. The common electrode 17 and the individual electrode 19 are positioned on the heat generating resistor 15. An exposed region where the heat generating resistor 15 is exposed is positioned between the common electrode 17 and the individual electrode 19. As illustrated in FIG. 2, the exposed regions of the heat generating resistors 15 are positioned in the form of a row on the raised portion 13b of the heat storage layer 13, and each exposed region constitutes the corresponding element of the heat generating part 9.

Note that the heat generating resistor 15 need not necessarily be positioned between each of the various electrodes and the heat storage layer 13. For example, the heat generating resistor 15 may be positioned only between the common electrode 17 and the individual electrode 19 so as to electrically connect the common electrode 17 and the individual electrode 19. In addition, the heat generating resistor 15 may be positioned between the heat storage layer 13 and each of the first connection electrode 21 and second connection electrode 26, or may be positioned between the ground electrode 4 and the heat storage layer 13.

Although elements of the heat generating parts 9 configured by the plurality of heat generating resistors 15 are illustrated in a simplified manner in FIG. 2 for convenience of description, the elements are positioned at a density from, for example, 100 dpi to 2400 dpi (dot per inch) or the like. The heat generating resistor 15 is made of, for example, a material having a relatively high electric resistance, such as a TaN-based material, a TaSiO-based material, a TaSiNO-based material, a TiSiO-based material, a TiSiCO-based material, or a NbSiO-based material. Therefore, when a voltage is applied to the heat generating part 9, the heat generating part 9 generates heat by Joule heat.

The common electrode 17 includes main wiring portions 17a and 17d, sub-wiring portions 17b, and lead portions 17c. The common electrode 17 electrically connects a plurality of elements constituting the heat generating part 9 and the connector 31. The main wiring portion 17a extends along the first long side 7a of the substrate 7. The sub-wiring portions 17b extend along each of the first short side 7c and the second short side 7d of the substrate 7. The lead portions 17c individually extend from the main wiring portion 17a toward each heat generating part 9. The main wiring portion 17d extends along the second long side 7b of the substrate 7.

The individual electrode 19 electrically connects the heat generating part 9 and the drive IC 11 to each other. In addition, a plurality of elements constituting the heat generating part 9 are divided into a plurality of groups. The individual electrodes 19 electrically connect elements of the heat generating part 9 constituting each group and the drive IC 11 corresponding to the group to each other. The individual electrode 19 is electrically connected to the drive IC 11 via the bonding material 24.

The first connection electrode 21 electrically connects the drive IC 11 and the connector 31 to each other. The plurality of first connection electrodes 21 each connected to the corresponding drive IC 11 are configured by a plurality of wirings having different functions.

The second connection electrode 26 electrically connects the drive ICs 11 adjacent to each other. The plurality of second connection electrodes 26 are configured by a plurality of wirings having different functions.

The common electrode 17, the first connection electrode 21, and the second connection electrode 26 are formed of a material having conductivity. The materials of the common electrode 17, the first connection electrode 21, and the second connection electrode 26 may be, for example, any one type of metal of aluminum, gold, silver, and copper, or an alloy thereof.

The individual electrode 19 is a so-called aluminum electrode. The individual electrode 19 contains, for example, aluminum or an aluminum alloy, and has electrical conductivity.

The ground electrode 4 is surrounded by the individual electrodes 19, the first connection electrodes 21, and the main wiring portion 17d of the common electrode 17. The ground electrode 4 is held at a ground potential from 0 V to 1 V.

A thickness of the individual electrode 19 is, for example, 0.5 μm or less, and may be, for example, about 0.1 μm to 0.5 μm. This makes it less likely for heat generated by the heat generating part 9 to dissipate via the individual electrode 19. In addition, by reducing a step from the substrate 7, for example, the protective layer 25 covering the heat generating part 9 becomes less likely to peel off, thereby improving the reliability of the thermal head X1.

In addition, thicknesses of the various electrodes except for the individual electrode 19 are, for example, about 0.1 μm to 10 μm, and may be, for example, about 0.3 μm to 5 μm. Note that the thicknesses of the various electrodes except for the individual electrode 19 may be the same as the thickness of the individual electrode 19.

The connection terminal 2 is positioned on the second long side 7b side of the substrate 7 and connects the common electrode 17, the individual electrode 19, the first connection electrode 21, and the ground electrode 4 to the connector 31. The connection terminal 2 is positioned so as to correspond to the connector pin 8, and when the connector 31 is connected, the connector pin 8 and the connection terminal 2 are connected so as to be electrically independent of each other.

As illustrated in FIG. 3, the electrically conductive member 23 is positioned on each connection terminal 2. Examples of the electrically conductive member 23 may include solder, and an anisotropic conductive paste (ACP). Note that a plating layer made of, for example, Ni, Au, or Pd may be positioned between the electrically conductive member 23 and the connection terminal 2.

The various electrodes constituting the head base 3 can be formed, for example, by sequentially laminating material layers of metals such as Al, Au, Ag, Cu or Ni, which constitute the respective electrodes, onto the heat storage layer 13 by a thin film forming technique such as a sputtering method, and then processing the resulting laminate body into a predetermined pattern by photoetching or the like. Note that the various electrodes constituting the head base 3 can be formed at the same time by the same process. In addition, the various electrodes can be made using, for example, a screen printing method, a flexographic printing method, a gravure printing method, a gravure offset printing method, or the like.

For example, the drive IC 11 is positioned on the first surface 7f side of the substrate 7. In addition, each of the plurality of drive ICs 11 is positioned along an arrangement direction of the heat generating parts 9 so as to correspond to each element of the heat generating parts 9 assigned to each drive IC 11. The drive IC 11 is connected to the individual electrode 19 and the first connection electrode 21. The drive IC 11 controls an energized state of the heat generating part 9. The drive IC 11 supplies, in accordance with an electric signal supplied from the outside, electrical power for individually causing each element of the heat generating part 9 to generate heat to the heat generating part 9. A switching IC including a plurality of switching elements inside, for example, may be used as the drive IC 11.

The bonding material 24 is positioned on the individual electrode 19 and electrically connects the drive IC 11 and the individual electrode 19. The bonding material 24 contains gold (Au) and tin (Sn) and has electrical conductivity. Since the bonding material 24 has high mechanical strength such as shear stress and is less likely to peel off from the individual electrode 19, the durability is enhanced. Note that bonding between the individual electrode 19 and the drive IC 11 by the bonding material 24 will be described in detail below.

The protective layer 25 is positioned on the heat storage layer 13 positioned on the first surface 7f side of the substrate 7. The protective layer 25 covers the heat generating resistor 15 including the heat generating part 9, the common electrode 17, and the individual electrode 19. More specifically, the protective layer 25 covers a part of the individual electrodes 19 from edges of the substrate 7, that is, the first long side 7a, the first short side 7c, and the second short 7d of the substrate 7. The protective layer 25 protects the covered region from corrosion due to adhesion of moisture or the like contained in the atmosphere or wear due to contact with the recording medium P to be printed (see FIG. 6). As the protective layer 25, for example, SiN, SiON, SiO₂, SiAlON, TiN, TiON, TiCrN, TiAlON, or the like can be used.

The covering layer 27 is positioned on the first surface 7f side of the substrate 7. The covering layer 27 partially covers the common electrode 17, the individual electrode 19, the first connection electrode 21, and the second connection electrode 26. The covering layer 27 protects the covered region from oxidation due to contact with the atmosphere or from corrosion due to adhesion of moisture or the like contained in the atmosphere. For the covering layer 27, a resin material such as an epoxy-based resin, a polyimide-based resin, or a silicone-based resin can be used.

The covering member 29 seals the drive IC 11 in a state where the drive IC is connected to the individual electrode 19, the second connection electrode 26, and the first connection electrode 21. The covering member 29 is disposed so as to extend in the main scanning direction and integrally seals the plurality of drive ICs 11. As the covering member 29, for example, a resin material such as an epoxy-based resin or a silicone-based resin can be used.

The connector 31 includes a plurality of connector pins 8 and a housing 10 in which the plurality of connector pins 8 are housed. The connector pin 8 has a first end and a second end and is electrically connected to various electrodes of the head base 3. The first end is exposed to the outside of the housing 10 and is electrically connected to the connection terminal 2 of the head base 3. The second end is accommodated inside the housing 10 and is drawn out to the outside.

The sealing member 12 includes a first sealing member 12a and a second sealing member 12b. The first sealing member 12a is positioned on the first surface 7f of the substrate 7. The first sealing member 12a seals the connector pins 8 and the various electrodes. The second sealing member 12b is positioned on the second surface 7g of the substrate 7. The second sealing member 12b is positioned so as to seal a contact portion between the connector pin 8 and the substrate 7.

The sealing member 12 is positioned such that the connection terminal 2 and the connector pin 8 are not exposed to the outside. The sealing member 12 can be made of, for example, an epoxy-based thermosetting resin, an ultraviolet curable resin, or a visible light curable resin. Note that the first sealing member 12a and the second sealing member 12b may be made of the same material. Further, the first sealing member 12a and the second sealing member 12b may be made of different materials.

The bonding member 14 is positioned on the heat dissipation body 1. The bonding member 14 bonds the second surface 7g of the head base 3 and the heat dissipation body 1. Examples of the bonding member 14 may include a double-sided tape and a resin adhesive.

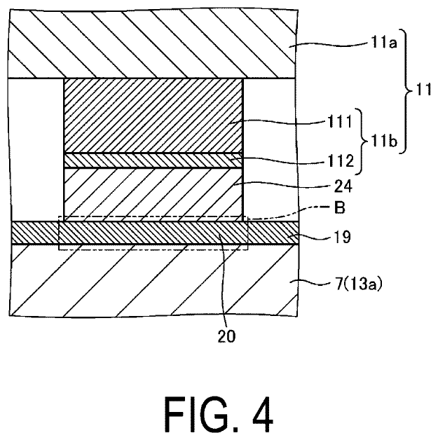

Next, the main portion of the thermal head X1 according to the embodiment will be described in detail with reference to FIG. 4. FIG. 4 is an enlarged cross-sectional view of a region A illustrated in FIG. 3. Note that in FIG. 4, the covering member 29 is omitted.

As shown in FIG. 4, the drive IC 11 includes an element portion 11a and a terminal portion 11b. The element portion 11a is a main portion that implements the above-described functions of the drive IC 11. The element portion 11a is an example of an electronic component.

The terminal portion 11b is electrically connected to the element portion 11a. The terminal portion 11b is electrically connected to the individual electrode 19 via the bonding material 24 positioned on the substrate 7, more specifically the underlying portion 13a. The terminal portion 11b is, for example, an electrically conductive metal member. The terminal portion 11b contains, for example, copper and nickel. The terminal portion 11b is an example of an electrically conductive member.

In addition, the terminal portion 11b may include a first layer 111 and a second layer 112. The first layer 111 contains, for example, copper. The first layer 111 can increase the bonding strength between the drive IC 11 and the individual electrode 19 by relaxing thermal stress, for example.

In addition, the second layer 112 is positioned closer to the substrate 7 than the first layer 111. The second layer 112 contains, for example, nickel. The second layer 112 can enhance the durability of the drive IC 11 by making it difficult for gold atoms and tin atoms positioned in the bonding material 24 to diffuse toward the element portion 11a side, for example. In addition, the second layer 112 can enhance the durability of the drive IC 11 by making it difficult for Cu atoms included in the first layer 111 to diffuse toward the bonding material 24 side, for example.

As such, the terminal portion 11b includes the first layer 111 and the second layer 112, thereby enhancing the bonding reliability between the drive IC 11 and the individual electrode 19. Note that the terminal portion 11b may include, for example, only one of the first layer 111 and the second layer 112, or may have an additional stacked structure in addition to the first layer 111 and the second layer 112.

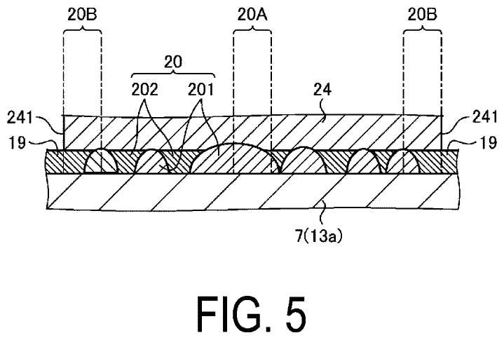

The bonding material 24 is positioned between the individual electrode 19 and the terminal portion 11b of the drive IC 11. The bonding material 24 has electrical conductivity and electrically connects the individual electrode 19 and the drive IC 11. A portion of the individual electrode 19 positioned between the substrate 7 and the bonding material 24, that is, a portion in contact with the bonding material 24 is referred to as a bonding region 20. Details of the bonding region 20 will be further described below with reference to FIG. 5.

FIG. 5 is an enlarged cross-sectional view of a region B illustrated in FIG. 4. As illustrated in FIG. 5, the bonding region 20 may include a first portion 201 and a second portion 202.

The first portion 201 has a higher content of gold than that of the individual electrode 19. Specifically, the first portion 201 may have, for example, 65% to 75% of Au atoms and 25% to 35% of Al atoms in terms of the volume ratio. Accordingly, the first portion 201 has improved bonding strength to the bonding material 24 as compared with the individual electrode 19 which is an aluminum electrode. Note that the first portion 201 may have a higher content of tin than that of the individual electrode 19.

The second portion 202 has a higher content of aluminum than that of the first portion 201. Specifically, the second portion 202 may have, for example, 0% to 10% of Au atoms and 90% to 100% of Al atoms in terms of the volume ratio. Accordingly, the second portion 202 has improved bonding strength to the substrate 7 as compared with the first portion 201.

As such, the bonding region 20 includes the first portion 201 and the second portion 202, thereby enhancing the adhesiveness between the bonding material 24 and the bonding region 20 and the adhesiveness between the bonding region 20 and the substrate 7. As a result, the bonding strength of the drive IC 11 is improved and the durability of the thermal head X1 is enhanced.

Here, a central portion 20A and an end portion 20B of the bonding region 20 are defined. The central portion 20A is positioned at a central portion in a width direction of the bonding material 24. The width direction of the bonding material 24 refers to a direction in which both end surfaces 241 of the bonding material 24 illustrated in FIG. 5 are connected. The end portion 20B is positioned at an end portion in the width direction of the bonding material 24 and includes portions in contact with both end surfaces 241 of the bonding material 24.

In such a case, the second portion 202 may be positioned at the end portion 20B of the bonding region 20. Positioning the second portion 202 at the end portion 20B further enhances the adhesiveness between the bonding region 20 and the substrate 7 and makes it less likely for peeling to occur.

In addition, an area proportion of the second portion 202 may be larger at the end portion 20B of the bonding region 20 than at the central portion 20A in the width direction of the bonding material 24. Here, the area proportion of the second portion 202 refers to an area ratio occupied by the second portion 202 in the bonding region 20 in a cross-sectional view. Setting the area proportion of the second portion 202 to be larger at the end portion 20B than that at the central portion 20A further enhances the adhesiveness between the bonding region 20 and the substrate 7 and makes it less likely for peeling to occur.

In addition, the first portion 201 may be thicker at the central portion than at the end portion. Accordingly, since the first portion 201 is less thick at the end portion in the width direction of the bonding material 24 on which stress is likely to be concentrated, the adhesiveness between the bonding region 20 and the substrate 7 is enhanced.

Note that the positions and shapes of the first portion 201 and the second portion 202 and the area proportion of the second portion 202 can be determined by visual observation based on a scanning electron microscope (SEM) image obtained by capturing a cross-section of the individual electrode 19 including the bonding region 20. Additionally, they can also be determined by observing the diffusion state of Au, Al, or Sn with electron probe micro analyzer (EPMA).

In addition, although not illustrated, the connection between the drive IC 11 and each of the ground electrode 4, first connection electrode 21, and second connection electrode 26 may also be the same as the connection between the drive IC 11 and the individual electrode 19 described above.

Next, a thermal printer Z1 including the thermal head X1 will be described with reference to FIG. 6. FIG. 6 is a schematic view of a thermal printer according to an embodiment.

In the present embodiment, the thermal printer Z1 includes the above-described thermal head X1, a transport mechanism 40, a platen roller 50, a power supply device 60, and a control device 70. The thermal head X1 is mounted to a mounting surface 80a of a mounting member 80 disposed in a housing (not illustrated) of the thermal printer Z1. Note that the thermal head X1 is mounted to the mounting member 80 such that the thermal head is aligned in the main scanning direction orthogonal to a transport direction S.

The transport mechanism 40 includes a drive unit (not illustrated) and transport rollers 43, 45, 47, and 49. The transport mechanism 40 transports a recording medium P, such as heat-sensitive paper or image-receiving paper to which ink is to be transferred, onto the protective layer 25 positioned on a plurality of heat generating parts 9 of the thermal head X1 in the transport direction S indicated by arrow. The drive unit has a function of driving the transport rollers 43, 45, 47, and 49, and a motor can be used for the drive unit, for example. The transport rollers 43, 45, 47, and 49 may be configured by, for example, covering cylindrical shaft bodies 43a, 45a, 47a, and 49a made of a metal, such as stainless steel, with elastic members 43b, 45b, 47b, and 49b made of butadiene rubber or the like. Note that, if the recording medium P is an image-receiving paper or the like to which ink is to be transferred, an ink film (not illustrated) is transported to a position between the recording medium P and the heat generating part 9 of the thermal head X1, together with the recording medium P.

The platen roller 50 has a function of pressing the recording medium P onto the protective layer 25 positioned on the heat generating part 9 of the thermal head X1. The platen roller 50 is disposed extending in a direction orthogonal to the transport direction S, and both end portions thereof are supported and fixed such that the platen roller 50 is rotatable while pressing the recording medium P onto the heat generating part 9. The platen roller 50 may be configured by, for example, covering a cylindrical shaft body 50a made of a metal, such as stainless steel, with an elastic member 50b made of butadiene rubber or the like.

As described above, the power supply device 60 has a function of supplying a current for causing the heat generating part 9 of the thermal head X1 to generate heat and a current for operating the drive IC 11. The control device 70 has a function of supplying a control signal for controlling an operation of the drive IC 11 to the drive IC 11 in order to selectively cause the heat generating parts 9 of the thermal head X1 to generate heat as described above.

The thermal printer Z1 performs predetermined printing on the recording medium P by selectively causing the heat generating parts 9 to generate heat with the power supply device 60 and the control device 70, while the platen roller 50 presses the recording medium P onto the heat generating parts 9 of the thermal head X1 and the transport mechanism 40 transports the recording medium P on the heat generating parts 9. Note that, if the recording medium P is image-receiving paper or the like, printing is performed onto the recording medium P by thermally transferring, to the recording medium P, ink of the ink film (not illustrated) transported together with the recording medium P.

Although an embodiment of the present disclosure has been described above, the present disclosure is not limited to the embodiment described above, and various changes can be made without departing from the spirit of the present disclosure. For example, although a planar head in which the heat generating part 9 is positioned on the main surface of the substrate 7 has been described, an end-surface head in which the heat generating part 9 is positioned on an end surface of the substrate 7 may be employed.

In addition, although description has been made using a so-called thin film head including the heat generating resistor 15 formed by sputtering, the present disclosure is not limited to the thin film head. A so-called thick film head including the heat generating resistor 15 formed by printing or the like may be used.

Additionally, the portion covering the bonding material 24 and the terminal portion 11b may be covered with an underfill material instead of the covering member 29. The underfill material can be made of, for example, a resin such as an epoxy resin having insulation.

Additionally, the heat generating part 9 may be formed by forming the common electrode 17 and the individual electrode 19 on the heat storage layer 13, and forming the heat generating resistor 15 only in a region between the common electrode 17 and the individual electrode 19.

Additionally, although the example in which the connector 31 is directly connected to the substrate 7 has been illustrated, a flexible printed circuit (FPC) may be connected to the substrate 7.

Additionally, although the thermal head X1 including the covering layer 27 has been exemplified, the covering layer 27 need not necessarily be provided. In this case, the protective layer 25 may be positioned up to a region where the covering layer 27 is provided. In addition, the covering layer 27 may be provided in a region other than the illustrated region.

Further effects and variations can be readily derived by those skilled in the art. Thus, a wide variety of aspects of the present disclosure are not limited to the specific details and representative embodiments represented and described above. Accordingly, various changes are possible without departing from the spirit or scope of the general inventive concepts defined by the appended claims and their equivalents.

1. A thermal head comprising:
a substrate;
a bonding material positioned on the substrate and containing gold and tin;
an electrically conductive member positioned on the bonding material; and
an aluminum electrode positioned on the substrate and electrically connected to the bonding material.

2. The thermal head according to claim 1, wherein the electrically conductive member comprises
a first layer containing copper and
a second layer positioned between the first layer and the bonding material and containing nickel.

3. The thermal head according to claim 1, wherein the aluminum electrode has a thickness of 0.5 μm or less.

4. The thermal head according to claim 1, wherein the bonding material is in contact with the aluminum electrode.

5. The thermal head according to claim 1, wherein
the aluminum electrode comprises a bonding region positioned between the substrate and the bonding material, and
the bonding region comprises
a first portion having a higher content of gold than that of the aluminum electrode, and
a second portion having a higher content of aluminum than that of the first portion.

6. The thermal head according to claim 5, wherein the second portion is positioned at an end portion of the bonding region in a width direction of the bonding material.

7. The thermal head according to claim 6, wherein an area proportion of the second portion is larger at the end portion than at a central portion of the bonding region in the width direction.

8. The thermal head according to claim 1, wherein the first portion is thicker at a central portion of the bonding region in a width direction of the bonding material than at an end portion thereof.

9. A thermal printer, comprising:
the thermal head described in claim 1;
a transport mechanism configured to transport a recording medium onto a heat generating part positioned on the substrate; and
a platen roller configured to press the recording medium onto the heat generating part.
